(19) United States
(12) Patent Application Publication
(10) Pub. No.: US 2006/0041101 A1
(43) Pub. Date: Feb. 23, 2006

(54) Conversion products of mixtures of long-chained fatty acids and aliphatic diamines, and the use thereof

(76) Inventors: Franz-Leo Heinrichs, Gablingen (DE); Ernst Rudolf Stalmann, Augsburg (DE); Norbert Pechler, Gersthofen (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/517,117

(22) PCT Filed: May 30, 2003
(86) PCT No.: PCT/EP03/05670

§ 371 Date: Aug. 17, 2005

(30) Foreign Application Priority Data
Jun. 5, 2002 (DE) 102 24 847.8

(51) Int. Cl. C08G 69/08

(52) U.S. Cl. 528/310

(57) ABSTRACT

The invention relates to conversion products of special mixtures of long-chained fatty acids and aliphatic diamines having an alkali number <10 and an acid number <15, and to the use of the same.

Reaction products of mixtures of long-chain fatty acids and aliphatic diamines and their use

The invention relates to reaction products of mixtures of low-chain fatty acids and aliphatic diamines and their use.

Due to the considerable increase in road traffic, in particular heavy vehicle traffic, the modification of bitumen (asphalt) to reduce road damage is now a necessity.

Bitumen is modified using high molecular weight compounds such as styrene-butadiene-styrene (SBS), amorphous poly-alpha-olefin (APAO), polyethylene (PE) or other polymers or low molecular weight compounds such as montan wax, Fischer-Tropsch wax, amide waxes or inorganic modifiers such as hydrated carbonate rock.

Polymer-modified bitumen has improved low-temperature flexibility, a somewhat increased softening point and slightly greater hardness compared to pure bitumen. However, the viscosity of polymer-modified bitumen at mixing, laying and compaction temperatures is considerably higher than in the case of unmodified bitumen. As a result, the ease of compaction or the compaction capability of the polymer-modified bitumen is reduced and the void content of the bitumen is increased, which leads to a reduction in the stability of the asphalt layer.

Low molecular weight additives such as montan wax, Fischer-Tropsch paraffins and others reduce the viscosity and improve the ease of compaction of the bitumen. The softening temperature of the bitumen is slightly increased as a function of the melting point of the modifier, but the low-temperature flexibility is considerably reduced, resulting in the disadvantage of increased brittleness temperatures. This is of particular importance when temperatures below 0° C. occur over a prolonged period of time.

The use and processing properties of bitumen for road construction asphalts are largely dependent on the hardness, the softening point, the viscosity and the low-temperature breaking point of the respective bitumen. To achieve good use and processing properties, a very broad plasticity range of the bitumen is necessary. For the purposes of the present invention, the plasticity range is the difference between the ring/ball softening point in accordance with DIN 52011/EN 1427 and the Fraaβ breaking point (DIN 52012/EN 12593).

Table 1 below gives an overview of the plasticity range of bitumen B80 with various additives.

TABLE 1
Plasticity range

| | | Amount | |
|---|---|---|---|
| Bitumen grade | Additives | (% by weight) | Plasticity range |
| Bitumen B80 | no additive | 0 | −15 . . . +50° C. |
| Bitumen B80 | SBS | 4% | −20 . . . +65° C. |
| Bitumen B80 | montan wax | 3% | 0 . . . +55° C. |
| Bitumen B80 | Fischer-Tropsch | 3% | −6 . . . +75° C. |
| Bitumen B80 | amide wax | 3% | −11 . . . +95° C. |

The weakest property is always the deciding factor in determining the quality of the asphalt.

Progress beyond the use of polymers or Fischer-Tropsch paraffins has been able to be achieved by modification of bitumen by means of amide waxes. Amide waxes are reaction products of ethylenediamine and hardened tallow fatty acid.

Commercially available amide wax for road construction is likewise a reaction product of ethylenediamine with hardened tallow fatty acid. Tallow fatty acid is obtained from tallow. It is a mixture of fatty acids having the composition:

TABLE 2
Composition of tallow fatty acids (figures in % by weight)

| Fatty acid | Unhardened | Hardened |
|---|---|---|
| Myristic acid | 1-7 | 1-7 |
| Palmitic acid | 20-35 | 20-35 |
| Stearic acid | 15-30 | 65-80 |
| Oleic acid | 20-50 | <2 |

Molecular interactions between the bitumen and the amide wax at elevated temperatures (>100° C.) reduce the viscosity of the bitumen in the asphalt. This improves the processability compared to unmodified bitumen. If the temperature in the processed asphalt drops below 100° C., the viscosity increases and the asphalt layer can be subjected to loads even at relatively high temperatures. This effect can strongly suppress the formation of ruts at elevated temperature and the life of the asphalt layer is increased. At the same time, it is possible to use softer bitumen, since the hardness of the bitumen is increased by the addition of amide wax.

A disadvantage of this modification is that the low-temperature flexibility of the modified bitumen is decreased compared to unmodified or polymer-modified bitumen. Thus, the Fraaβ breaking points of various products offered on the market are from −10 to −13° C. or from −10 to −11° C. or even only from −6 to −8° C. Such bitumens are unsuitable for long-term use at relatively low temperatures.

It is therefore an object of the present invention to find a modifier for bitumen which displays the positive properties of commercial amide wax without at the same time adversely affecting the low-temperature properties of the bitumen. This object is achieved by reaction products of mixtures of long-chain fatty acids and aliphatic diamines having an alkali number of <10 and an acid number of <15.

The ratio of mixtures of the long-chain fatty acids to aliphatic diamines is preferably 2 to 1.

The mixture of long-chain fatty acids preferably comprises
0-7% by weight of myristic acid
0-85% by weight of palmitic acid
0-85% by weight of stearic acid
0-10% by weight of oleic acid
0-90% by weight of 12-hydroxystearic acid,
   where the sum is always 100% by weight.

Both pure (100%) hydroxystearic acid and technical-grade hydroxystearic acid (about 90% together with other fatty acids) are suitable here.

The mixture of long-chain fatty acids preferably comprises
0-7% by weight of myristic acid
34-64% by weight of palmitic acid
64-45% by weight of stearic acid
0-10% by weight of oleic acid,
   where the sum is always 100% by weight.

The mixture of long-chain fatty acids particularly preferably comprises
0-5% by weight of myristic acid
40-60% by weight of palmitic acid
60-40% by weight of stearic acid
0-5% by weight of oleic acid,
   where the sum is always 100% by weight.
   Preference is given to natural or synthetic fatty acids being present as additional constituents.

Preference is given to using ethylenediamine as aliphatic diamine.

The reaction products preferably further comprise saturated and/or unsaturated dicarboxylic acids.

The ratio of mixtures of long-chain carboxylic acids to aliphatic diamines to dicarboxylic acids is preferably (1.8-1.98):1.0:(0.1-0.01).

The sum of the carboxyl functionality is preferably always 2. For the purposes of the present invention, the carboxyl functionality is the group —COOH and derivatives thereof, e.g. —COOR where R=alkyl and —CONR₂ where R=H or alkyl.

In the case of the reaction products which further comprise saturated and/or unsaturated dicarboxylic acids, an alkali number of <10 and an acid number of <15 are preferably set.

In the case of reaction products which further comprise saturated and/or unsaturated dicarboxylic acids, the mixture of long-chain fatty acids preferably comprises
0-7% by weight of myristic acid
20-85% by weight of palmitic acid
85-45% by weight of stearic acid
0-10% by weight of oleic acid,
   where the sum is always 100% by weight.

The mixture of long-chain fatty acids in this case preferably comprises
0-5% by weight of myristic acid
20-80% by weight of palmitic acid
80-20% by weight of stearic acid
0-10% by weight of oleic acid,
   where the sum is always 100% by weight.

In the case of the reaction products which further comprise saturated and/or unsaturated dicarboxylic acids, preference is given to using ethylenediamine in combination with linear and/or cycloaliphatic diamines as diamine components.

This combination preferably comprises
from 50 to 100% by weight of ethylenediamine and
from 0 to 50% by weight of linear and/or cycloaliphatic diamines.

The combination particularly preferably comprises
from 95 to 99.99% by weight of ethylene diamine and
from 0.01 to 5% by weight of linear and/or cycloaliphatic diamines.

Preference is given to using ethylenediamine in combination with linear or cycloaliphatic diamines such as hexamethylenediamine or TCD-diamine (tricyclodecanediamine) as diamine component.

The mixture of long-chain fatty acids in this case preferably comprises
0-7% by weight of myristic acid
0-85% by weight of palmitic acid
0-85% by weight of stearic acid
0-10% by weight of oleic acid,
0-90% by weight of 12-hydroxystearic acid,
   where the sum is always 100% by weight.

The object of the invention is also achieved by a process for preparing reaction products of mixtures of long-chain fatty acids and aliphatic diamines, wherein an alkali number of <10 and an acid number of <15 are set for the reaction product.

Finally, the invention also provides for the use of the reaction products according to the invention as modifiers for bitumen.

In the examples, the influence of the composition of the fatty acids used as raw materials for the preparation of the amide wax was examined. Tests were carried out on mixtures of saturated fatty acids of various chain lengths, the influence of unsaturated fatty acids and of hydroxy fatty acids in these mixtures, the influence of dimeric fatty acids and also variation of the amine component.

The products were prepared by known methods and tested in blends with bitumen B80 3 ppH (Shell, GFK, Miro). The parameters relevant for the processing and quality of the asphalt, viz. viscosity, softening point (ring/ball, DIN 52011, EN 1427), needle penetration and Fraaβ breaking point (DIN 52012, EN 12593), were examined. As comparative examples, products from standard fatty acid mixtures and commercially available EBS products (ethylenebisstearoyidiamine) were tested.

It was surprisingly found that specific combinations of the fatty acids and sometimes additional variations in the diamine component and the addition of dimeric fatty acid effects an improvement compared to the prior art.

### EXAMPLES

General Method of Preparation

The fatty acid is introduced in the indicated amount (liquid) into a 1 l pressure reactor. The reactor is closed, made inert and heated to 140° C. At this temperature, the amine is metered in. After the addition of the amine, the mixture is heated to 200° C. and the water of reaction is distilled off. The pressure in the reactor is set to about 2 bar during this. After the reaction is complete, the mixture is cooled to 150° C., the reactor is depressurized to atmospheric pressure and the melt is poured out. To characterize the product, the alkali number (DGF standard method M IV 4), acid number (DIN 53403) and drop melting point (DIN 51801/2, ASTM D 127) were determined by the known methods indicated.

The composition of the fatty acids and fatty acid mixtures used was calculated according to the acid number and tested by means of gas chromatography. Commercially available amide waxes recommended for this application were used for comparison. The fatty acid composition of the commercial products was tested by means of gas chromatography. The Fraaβ values were determined on a mixture of 3 parts of wax and 97 parts of bitumen B80.

TABLE 3
Example waxes and comparative products from ethylene-diamine and monocarboxylic acid mixtures

| | Example | | | | | | | |
|---|---|---|---|---|---|---|---|---|
| | 1 | 2 | 3 | 4 | 5 | 6 | 7 | 8 |
| Ethylenediamine | 1 | 1 | 1 | 1 | 1 | 1 | 1 | |
| Stearic acid 98-100 | | | | 2 | | | | |
| Tallow fatty acid 80/20 | | 2 | | | | | | |
| Tallow fatty acid 70/30 | 2 | | 2 | | | | | |
| Palmitic acid 98-100 | | | | | 2 | | | |
| Tallow fatty acid 65/35 | | | | | | 1 | | |
| Tallow fatty acid 60/40 | | | | | | | 2 | |
| Tallow fatty acid 55/45 | | | | | | | | 2 |
| Acid No. | 5 | 5 | 5 | 10 | 9 | 3 | 8 | 9 |
| Alkali No. | 5 | 5 | 5 | 5 | 5 | 105 | 7 | 5 |
| Dmp | 144 | 144 | 144 | 144 | 146 | 126 | 144 | 144 |
| Fraaβ value | −10-13 | −10-11 | −6-8 | −15-17 | −14-16 | −17 20.- | −15.-18 | −15.-18 |

TABLE 4
Example waxes from ethylenedlamine and monocarboxylic
acid mixtures with addition of aliphatic diamines

| | Example | | | | | | | |
|---|---|---|---|---|---|---|---|---|
| | 9 | 10 | 11 | 12 | 13 | 14 | 15 | 16 |
| Ethylenediamine | 1 | 1 | 1 | 1 | 1 | 1 | 1 | 1 |
| Hexamethylenediamine | | 0.03 | 0.03 | | | 0.03 | | |
| TCD-diamine | | | | 0.03 | 0.03 | | 0.02 | |
| Tallow fatty acid 80/20 | | | | | | 2.06 | | |
| Tallow fatty acid 70/30 | | | | 2.03 | | | | |
| Tallow fatty acid 60/40 | | 1.96 | | | | | | |
| Tallow fatty acid 55/45 | 1.87 | | 2.03 | | 1.96 | | | |
| Tallow fatty acid 50/50 | | | | | | | 2.02 | |
| Oleic acid | 0.17 | 0.09 | | | 0.09 | | | |
| 12-Hydroxystearic acid | | | | | | | | 2 |
| Acid number | 10 | 9 | 7 | 8 | 11 | 15 | 5 | 8 |
| Alkali number | 4 | 6 | 2 | 4 | 8 | 9 | 5 | 12 |
| Drop melting point | 136 | 138 | 139 | 138 | 136 | 138 | 142 | 140 |
| Fraaβ value | −14.-16 | −15.-17 | −14.-16 | −15.-18 | −15.-17 | −13.-18 | −15.-18 | −14.-16 |

TABLE 5
Example waxes from ethylenediamine and monocarboxylic acid mixtures with
addition of aliphatic diamines and/or aliphatic dicarboxylic acids

| | Example | | | | | | |
|---|---|---|---|---|---|---|---|
| | 17 | 18 | 19 | 20 | 21 | 22 | 23 |
| Ethylenediamine | 1 | 1 | 1 | 1 | | 1 | |
| Hexamethylenediamine | | | 0.04 | 0.05 | 1 | | 1 |
| TCD-diamine | | | | | | | |
| Tallow fatty acid 80/20 | | | | | | | |
| Tallow fatty acid 70/30 | | | | 2 | | | |
| Tallow fatty acid 65/35 | | | | | 1.82 | 1.82 | 1.82 |
| Tallow fatty acid 60/40 | | | | | | | |
| Tallow fatty acid 55/45 | 1.87 | 1.83 | 2.03 | | | | |
| Tallow fatty acid 45/50 | | | | | | | |
| Oleic acid | | | | | | | |
| Hydroxystearic acid | | | | | | | |
| Dimeric fatty acid 1025 | | 0.08 | 0.05 | | | | |
| Adipic acid | 0.07 | | | 0.05 | | | |
| Sebactic acid | | | | | 0.09 | 0.09 | |
| Dodecanedioic acid | | | | | | | 0.09 |
| Acid number | 10 | 10 | 12 | 8 | 8 | 15 | 6 |
| Alkali number | 4 | 5 | 5 | 2 | 1 | 3 | 2 |
| Drop melting point | 151 | 138 | 136 | 159 | 149 | 180 | 148 |
| Fraaβ value | −10 . . . -13 | −17 . . . -20 | −16 . . . -20 | −16 . . . -19 | −12 . . . -14 | −11 . . . -14 | −11 . . . -13 |

The measured values for the breaking point show that the character of the fatty acid and the chain distribution in the fatty acid mixture have a considerable influence on the properties of the bitumen. In the case of the pure fatty acids, the values are at low temperatures, but pure fatty acids are economically unattractive, while naturally occurring fatty acid mixtures such as hardened tallow fatty acid or hardened palm kernel acid lead to the rise in the breaking point described above.

Only when the fatty acid compositions according to the invention are used or other aliphatic diamines are added or aliphatic dicarboxylic acids are added to tallow fatty acids does the reaction form products having a low breaking point in the bitumen mixture. A surprising exception is found when use is made of hydroxystearic acid which displays low breaking points both in pure form and in combination with tallow fatty acid.

Physical Tests:

Three parts of wax are mixed with 97 parts of bitumen at 180° C. for 30 minutes. The liquid mixture is cast. The tests are carried out on samples of the casting composition. The results of the tests are shown in the following tables.

TABLE 6a
Properties of bitumen blends with 3% of modifier from Table 3

| | | | Compravative wax | | | | | |
|---|---|---|---|---|---|---|---|---|
| | | | from | from | from | from | from | from |
| | | | Example | Example | Example No. | Example | Example | Example |
| | | | No. 7 | No. 4 | 5 | No. 21 | No. 22 | No. 23 |
| | | B80 | Invention | Comparison* | Comparison* | Clariant | FACI | Clariant |
| Tallow fatty acid | | alone | 60/40 | 98/2 | 2/98 | 70/30 | 65/35 | 70/30* |
| Comparison | | | | | | | | |
| Viscosity mPas | Method a | 100 | 40 | 60 | 45 | 55 | 55 | 50 |
| | Method b | 80 | 50 | 60 | 50 | 50 | 60 | 50 |
| Softening point | | 52 | 100 | 95 | 95 | 85 | 87 | 85 |
| Ring/ball ° C. | | | | | | | | |
| Needle penetration in | | 75 | 42 | 39 | 41 | 45 | 43 | 48 |
| 1/10 mm | | | | | | | | |
| Fraaβ breaking | c | −17- . . . −19 | −14- . . . −15 | −15- . . . −17 | −13 . . . −15 | −11- . . . −13 | −10- . . . −11 | −6- . . . −8 |
| point ° C.** | | | | | | | | |

Comparison*: Waxes from pure raw materials for comparison
Fraaβ breaking point ° C.**: Trial with 5 measured points, min + max
Viscosities cone and plate at 180° C./in mPas
a = D: 100 1/s
b = D: 300 1/s

TABLE 6b
Properties of bitumen blends with 3% of modifier from Table 4

| | | Wax from example | | | | |
|---|---|---|---|---|---|---|
| | | 9 | 10 | 13 | 15 | 16 |
| | | Invention | Invention | Invention | Invention | Invention |
| Viscosity mPas | a | 60 | 55 | 50 | 60 | 50 |
| | b | 60 | 65 | 60 | 60 | 60 |
| Softening point ring/ball | | 99 | 100 | 98 | 97 | 88 |
| Needle penetration in | | 51 | 47 | 49 | 46 | 46 |
| 1/10 mm | | | | | | |
| Fraaβ breaking point | c | −14- . . . −16 | −15- . . . −17 | −15 . . . −17 | −15- . . . −18 | −14 . . . −16 |
| ° C. | | | | | | |

Fraaβ breaking point ° C.: Trial with 5 measured points, min + max
Viscosities cone and plate at 180° C./in mPas
a = D: 100 1/s
b = D: 300 1/s

TABLE 6c
Properties of bitumen blends with 3% of modifier from Table 5

| | | Wax from example | | | | | |
|---|---|---|---|---|---|---|---|
| | | 18 | 21 | 19 | 20 | 22 | 23 |
| | | Invention | Invention | Invention | Invention | Invention | Invention |
| Viscosity mPas | a | 50 | 70 | 40 | 40 | 50 | 40 |
| | b | 50 | 65 | 50 | 50 | 60 | 50 |
| Softening point | | 98 | 97 | 102 | 97 | 100 | 99 |
| ring/ball ° C. | | | | | | | |
| Needle penetration in | | 42 | 40 | 52 | 43 | 38 | 41 |
| 1/10 mm | | | | | | | |
| Fraaβ breaking point | | −17 . . . −20 | −12- . . . −14 | −16 . . . −20 | −16 . . . −19 | −11 . . . −13 | −11 . . . −14 |
| ° C. | | | | | | | |

Fraaβ breaking point ° C.: Trial with 5 measured points, min + max
Viscosities cone and plate at 180° C./in mPas
a = D: 100 1/s
b = D: 300 1/s

Use testing in the rut test has shown that the modification of the chain distribution results in no noticeable disadvantages in use.

Rut test, penetration depth in mm

| Wax type | Unmodified | Example 1 | Example 7 |
|---|---|---|---|
| Poured asphalt | 8 | 4 | 3.9 |
| Load-bearing layer | 3 | 0.8 | 0.8 |
| Mastic asphalt | 3.8 | 0.8 | 0.9 |
| Asphalt binder | 5.3 | 1.2 | 1.1 |

Evaluation:

Unmodified bitumen has a high viscosity, a low softening point and a high needle penetration hardness. However, it fractures only at relatively low temperatures. The addition of about 3% of amide wax decreases the viscosity at processing temperature, improves the wetting behavior and increases the softening point. However, when products which are not according to the invention are used, the Fraaβ breaking point is shifted to significantly higher temperatures.

In contrast, if reaction products of mixtures of long-chain fatty acids and aliphatic diamines (amide waxes) according to the invention are used, the good effects of the standard products are retained, but the breaking point is brought back down into the temperature range of unmodified bitumen. The use test shows that the alteration results in no disadvantages in the load-bearing capability in the rut test.

1. A reaction product of a mixture of long-chain fatty acids and at least one aliphatic diamine, wherein the reaction product has an alkali number of <10 and an acid number of <15.

2. The reaction product as claimed in claim 1, wherein the ratio of the mixture of long-chain fatty acids to the at least one aliphatic diamine is 2 to 1.

3. The reaction product as claimed in claim 1, wherein the mixture of long-chain fatty acids further comprises
0-7% by weight of myristic acid
0-85% by weight of palmitic acid
0-85% by weight of stearic acid
0-10% by weight of oleic acid
0-90% by weight of 12-hydroxystearic acid, and
where the sum is always 100% by weight.

4. The reaction product as claimed in claim 1, wherein the mixture of long-chain fatty acids further comprises
0-7% by weight of myristic acid
34-64% by weight of palmitic acid
64-45% by weight of stearic acid
0-10% by weight of oleic acid, and
where the sum is always 100% by weight.

5. The reaction product as claimed in claim 1, wherein the mixture of long-chain fatty acids further comprises
0-5% by weight of myristic acid
40-60% by weight of palmitic acid
60-40% by weight of stearic acid, and
0-5% by weight of oleic acid,
where the sum is always 100% by weight.

6. The reaction product as claimed in claim 1, further comprising at least one natural or synthetic fatty acid.

7. The reaction product as claimed in claim 1, wherein the at least one aliphatic diamine is ethylenediamine.

8. The reaction product as claimed in claim 1, further comprising at least one saturated or unsaturated dicarboxylic acid or a mixture thereof.

9. The reaction product as claimed in claim 8, wherein the ratio of the mixture of long-chain fatty acids to the at least one aliphatic diamine to the at least dicarboxylic acid is (1.8-1.98):1.0:(0.1-0.01).

10. The reaction product as claimed in claim 8, wherein the sum of the carboxyl functionality is always 2.

11. The reaction product as claimed in claim 1, having an alkali number of <10 and an acid number of <15.

12. The reaction product as claimed in claim 8, wherein the mixture of long-chain fatty acids further comprises
0-7% by weight of myristic acid
20-85% by weight of palmitic acid
85-45% by weight of stearic acid, and
0-10% by weight of oleic acid,
where the sum is always 100% by weight.

13. The reaction product as claimed in claim 8, wherein the mixture of long-chain fatty acids further comprises
0-5% by weight of myristic acid
20-80% by weight of palmitic acid
80-20% by weight of stearic acid, and
0-10% by weight of oleic acid,
where the sum is always 100% by weight.

14. The reaction product as claimed in claim 8, wherein the at least aliphatic diamine ethylenediamine in combination with linear and/or cycloaliphatic diamines.

15. The reaction product as claimed in claim 8, wherein the at least one aliphatic diamine further comprises
from 50 to 100% by weight of ethylenediamine and
from 0 to 50% by weight of linear and/or cycloaliphatic diamines.

16. The reaction product as claimed claim 8, wherein the at least one aliphatic diamine further comprises
from 95 to 99.99% by weight of ethylenediamine and
from 0.01 to 5% by weight of linear and/or cycloaliphatic diamines.

17. The reaction product as claimed in claim 8, wherein the at least one aliphatic diamine is ethylenediamine in combination hexamethylenediamine, tricyclodecanediamine or mixtures thereof.

18. The reaction product as claimed in claim 8, wherein the mixture of long-chain fatty acids further comprises
0-7% by weight of myristic acid
0-85% by weight of palmitic acid
0-85% by weight of stearic acid
0-10% by weight of oleic acid, and
0-90% by weight of 12-hydroxystearic acid,
where the sum is always 100% by weight.

19. A process for preparing a reaction product as claimed in claim 1, comprising the step of setting an alkali number of <10 and an acid number of <15 for the reaction product.

20. A method for modifying bitumen comprising the step of adding a reaction product as claimed in claim 1 to the bitumen.

21. Bitumen made in accordance with the method of claim 20.
